(19) United States
(12) Patent Application Publication
(10) Pub. No.: US 2015/0240987 A1
(43) Pub. Date: Aug. 27, 2015

(54) Method and Apparatus for Removably Attaching Photogrammetric Targets to a Surface

(71) Applicant: The Boeing Company, Chicago, IL (US)

(72) Inventors: Matthew Ray DesJardien, Kenmore, WA (US); Christie Dusty Lagally, Seattle, WA (US)

(73) Assignee: The Boeing Company, Chicago, IL (US)

(21) Appl. No.: 14/189,381

(22) Filed: Feb. 25, 2014

(51) Int. Cl. F16M 13/02; G01C 11/00; H04N 13/02; G01B 11/24

(52) U.S. Cl. CPC F16M 13/02; G01B 11/24; G01C 11/00; H04N 13/0275; H04N 13/0296

(57) ABSTRACT

A method and apparatus for removably attaching a magnetic target for a photogrammetry system to a surface of a structure. A retaining member may comprise a body, an engagement material associated with the body, and a magnetic material associated with the body. The engagement material may be configured for use in removably attaching the retaining member to the surface of the structure. The magnetic material may be configured for use in removably attaching a magnetic target to the retaining member.

### BACKGROUND INFORMATION

1. Field

The present disclosure relates generally to photogrammetry and, in particular, to targets used for photogrammetry. Still more particularly, the present disclosure relates to a method and apparatus for removably attaching photogrammetric targets to a surface of a structure.

2. Background

Photogrammetry is the science of using images and, in some cases, other sensor data, to generate an output, such as, for example, without limitation, a map, a three-dimensional model, a three-dimensional point cloud, a topographical product, or some other type of output. As one example, photogrammetry may be used to generate a three-dimensional map of a surface of a structure, such as the wing of an aircraft, the fuselage of an aircraft, the hull of a ship, or some other type of structure.

Typically with photogrammetry, targets are attached onto the surface of the structure being captured in the images generated by a photogrammetric system. A target may be any item capable of being captured in an image that is distinguishable from the rest of the surface of the structure. For example, the target, which may be referred to as a photogrammetric target, may take the form of a sticker, a magnet having a particular pattern on one side of the magnet, a label, a piece of tape, or some other type of target.

Some currently available targets may cause undesired effects on the surface of the structure when these targets are attached to the surface, removed from the surface, or both. For example, without limitation, attaching a target to or removing a target from a painted surface may mark the painted surface in an undesired manner or undesirably affect the painted surface in some other way.

Thus, it may be desirable to have targets that may be removably attached onto the surface of a structure. Removably attaching a target onto a surface means attaching the target to the surface in a manner such that the target may be removed from the surface at a later time without causing any undesired effects on the surface or to the finish of the surface outside of selected tolerances.

However, removably attaching some currently available targets onto surfaces may be more time-consuming, difficult, or expensive than desired. In some cases, the attachment, removal, or both of a target that has been removably attached to the surface of a structure may cause undesired effects on the paint, finish, or other properties of the surface. Therefore, it would be desirable to have a method and apparatus that take into account at least some of the issues discussed above, as well as other possible issues.

### SUMMARY

In one illustrative embodiment, a retaining member may comprise a body, an engagement material associated with the body, and a magnetic material associated with the body. The engagement material may be configured for use in removably attaching the retaining member to a surface of a structure. The magnetic material may be configured for use in removably attaching a magnetic target to the retaining member.

In another illustrative embodiment, a retaining member may comprise a body and a set of stabilizing features associated with the body. The body may have a non-adhesive side and an adhesive side. The adhesive side may be configured for use in removably attaching the retaining member to a surface of a structure. The set of stabilizing features may be configured to hold a photogrammetric target for a photogrammetry system in a fixed position relative to the body when the retaining member is removably attached to the surface of the structure.

In yet another illustrative embodiment, a photogrammetry system may comprise a number of magnetic targets, a number of retaining members, and an imaging system. The number of retaining members may be configured for use in removably attaching the number of magnetic targets to a curved surface of a structure. A retaining member in the number of retaining members may comprise a body having a first side and a second side, a magnetic material associated with the first side of the body, and an engagement material associated with the second side of the body. The retaining member may be configured to hold a magnetic target for the photogrammetry system in a fixed position relative to the retaining member using the magnetic material. The retaining member may be further configured to be removably attached to the curved surface of the structure using the engagement material. The imaging system may be configured to generate image data of the curved surface of the structure with the number of magnetic targets removably attached to the curved surface of the structure for use in generating a three-dimensional model of the curved surface of the structure.

In still another illustrative embodiment, a method for removably attaching a magnetic target for a photogrammetry system to a surface of a structure may be provided. A retaining member may be removably attached to the surface of the structure using an engagement material. The magnetic target may be removably attached to the retaining member using a magnetic material associated with the retaining member.

In yet another illustrative embodiment, a method for removably attaching a photogrammetric target for a photogrammetry system to a surface of a structure may be provided. The photogrammetric target may be held in a fixed position relative to a body of a retaining member using a set of stabilizing features associated with the body. The retaining member may be removably attached to the surface of the structure using an adhesive side of the body.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an imaging environment in the form of a block diagram in accordance with an illustrative embodiment;

FIG. 2 is an illustration of an isometric view of a photogrammetric environment in accordance with an illustrative embodiment;

FIG. 3 is an illustration of a spool of retaining tape in accordance with an illustrative embodiment;

FIG. 4 is an illustration of a magnetic target in accordance with an illustrative embodiment;

FIG. 5 is an illustration of magnetic targets being removably attached to a surface of a fuselage of an aircraft in accordance with an illustrative embodiment;

FIG. 6 is an illustration of a plurality of stickers in accordance with an illustrative embodiment;

FIG. 7 is an illustration of an isometric view of a retaining member in accordance with an illustrative embodiment;

FIG. 8 is an illustration of a front view of a retaining member holding a coded target in accordance with an illustrative embodiment;

FIG. 9 is an illustration of an isometric view of a retaining member in accordance with an illustrative embodiment;

FIG. 10 is an illustration of a front view of a retaining member holding a target in accordance with an illustrative embodiment;

FIG. 11 is an illustration of a front view of a different type of retaining member in accordance with an illustrative embodiment;

FIG. 12 is an illustration of a front view of different types of retaining members in accordance with an illustrative embodiment;

FIG. 13 is an illustration of a front view of another type of retaining member in accordance with an illustrative embodiment;

FIG. 14 is an illustration of an isometric view of a retaining member in accordance with an illustrative embodiment;

FIG. 15 is an illustration of a front view of a retaining member in accordance with an illustrative embodiment;

FIG. 16 is an illustration of a process for removably attaching a magnetic target for a photogrammetry system to a surface of a structure in the form of a flowchart in accordance with an illustrative embodiment;

FIG. 17 is an illustration of a process for removably attaching a target for a photogrammetry system to a surface of a structure in the form of a flowchart in accordance with an illustrative embodiment;

FIG. 18 is an illustration of an illustration of a process for using photogrammetry to generate a three-dimensional model of a structure in the form of a flowchart in the form of a flowchart in accordance with an illustrative embodiment;

FIG. 19 is an illustration of an aircraft manufacturing and service method in the form of a block diagram in accordance with an illustrative embodiment; and

FIG. 20 is an illustration of an aircraft in the form of a block diagram in which an illustrative embodiment may be implemented.

### DETAILED DESCRIPTION

The illustrative embodiments recognize and take into account different considerations. For example, the illustrative embodiments recognize and take into account that it may be desirable to have a method and apparatus for removably attaching a photogrammetric target to a surface of a structure in a manner such that attachment or removal of the photogrammetric target does not cause any undesired effects on the surface. Further, the illustrative embodiments recognize and take into account that it may be desirable to have a method and apparatus that reduces the time, effort, and expense involved in removably attaching photogrammetric targets onto the surfaces of structures.

Thus, the illustrative embodiments provide a retaining member for use in removably attaching a target to a surface of a structure. In some illustrative examples, the retaining member may be configured to be handled by a robotic device such that the process of removably attaching the targets to the surface of a structure and removing the target from the surface may be automated.

Using a robotic device may allow the targets to be more precisely and quickly attached to retaining members and the retaining members to be more precisely and quickly attached onto the surface of the structure in desired locations as compared to manually attaching the targets. Increasing the precision with which targets are removably attached to surfaces through retaining members may improve the accuracy of the output generated by the photogrammetry system with which the targets are used.

Further, using a robotic device may allow the targets to be more quickly removed from the retaining members holding the targets and the retaining members to be more quickly removed from the surface of the structure. Thus, using a robotic device to removably attach targets to and remove targets from a surface of a structure may reduce the overall amount of time and effort needed for these processes, while achieving a desired level of precision in these processes.

Further, using a robot may allow these processes to be repeated for different surfaces more efficiently and precisely. For example, using a robotic device may allow the processes of removably attaching and removing to be repeatedly performed for different surfaces of the same structure or different structures with a desired level of speed and precision.

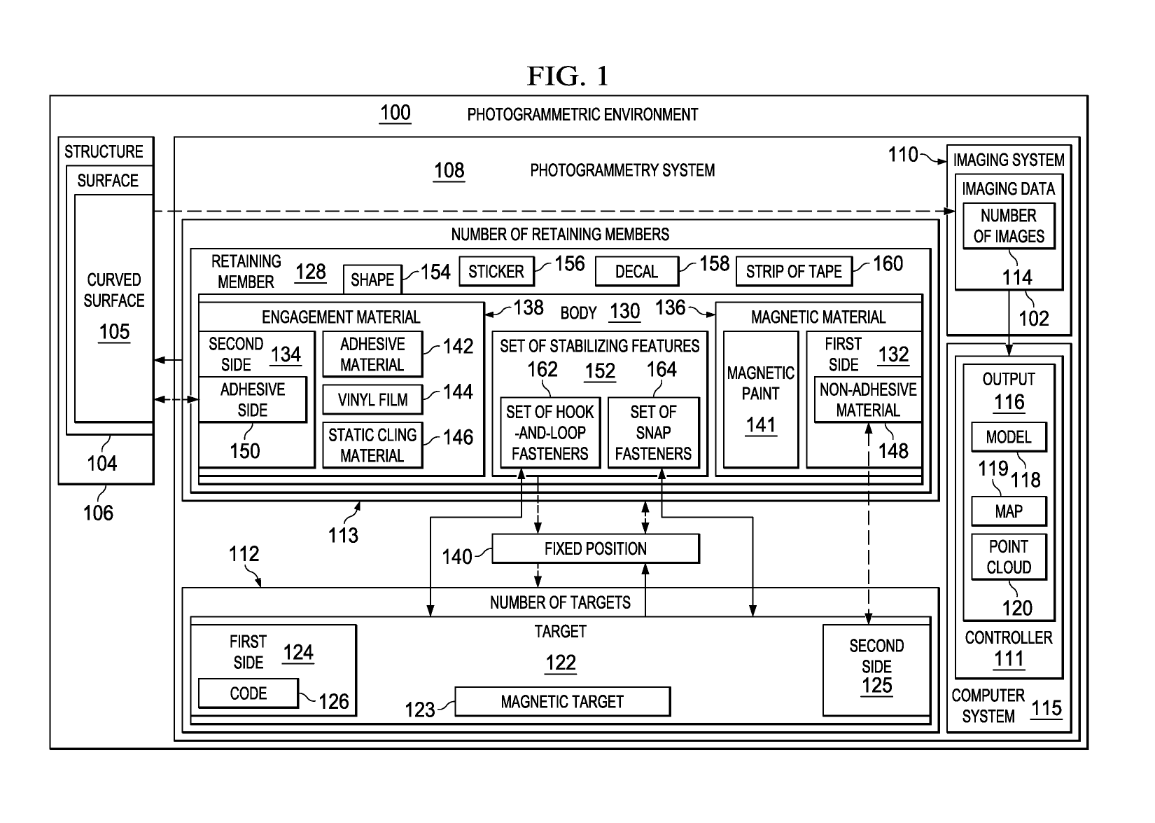

Referring now to the figures and, in particular, with reference to FIG. 1, an illustration of an imaging environment is depicted in the form of a block diagram in accordance with an illustrative embodiment. In this illustrative example, photogrammetric environment 100 may be an example of an environment in which imaging data 102 of surface 104 of structure 106 may be generated using photogrammetry system 108.

Structure 106 may take a number of different forms. For example, without limitation, structure 106 may take the form of an aircraft, the wing of an aircraft, the fuselage of an aircraft, a ship, the hull of a ship, the deck of a ship, a skin panel, a spherical structure, or some other type of structure. In one illustrative example, surface 104 may be substantially planar. In other illustrative examples, surface 104 may take the form of curved surface 105. Curved surface 105 may have any number of curvatures along curved surface 105.

As depicted, photogrammetry system 108 may include imaging system 110, controller 111, number of targets 112, and number of retaining members 113. As used herein, a “number of” items may include one or more items. In this manner, number of targets 112 may include one or more images.

Imaging system 110 may be used to generate imaging data 102. Imaging data 102 may take the form of number of images 114 in one illustrative example. Imaging system 110 may be implemented using any number of electro-optical imaging devices, infrared imaging devices, stereo cameras, other types of imaging devices, or some combination thereof. Controller 111 may be configured to receive and process imaging data 102 generated by imaging system 110.

Controller 111 may be implemented using hardware, software, or a combination of the two. In one illustrative example, controller 111 may be implemented using computer system 115. Computer system 115 may be comprised of one or more computers, depending on the implementation.

Controller 111 may generate output 116. Output 116 may take a number of different forms, depending on the implementation. In one illustrative example, output 116 may take the form of model 118. Model 118 may be a three-dimensional model in this example. In other illustrative examples, output 116 may take the form of map 119, point cloud 120, or some other suitable form. Depending on the implementation, map 119 or point cloud 120 may be two-dimensional or three-dimensional.

Number of targets 112 may be removably attached to surface 104 of structure 106 using number of retaining members 113. Number of targets 112 may be captured in imaging data 102 by imaging system 110. Controller 111 may identify number of targets 112 in imaging data 102 and use the identification to generate output 116.

As used herein, a “target,” such as one of number of targets 112, may be any object that can be captured by imaging system 110 in number of images 114 and is distinguishable from surface 104 of structure 106. A target in number of targets 112 may also be referred to as a photogrammetric target.

Target 122 may be an example of a target in number of targets 112. Target 122 may have first side 124 and second side 125. In one illustrative example, code 126 may be visible on first side 124 of target 122. In this example, first side 124 may be referred to as the coded side of target 122. When target 122 has code 126, target 122 may be referred to as a coded target.

Code 126 may take the form of any type of pattern that may distinguish target 122 from the other targets in number of targets 112. In other words, code 126 may be an identifier for target 122. Code 126 may take the form of, for example, without limitation, a pattern of shapes or markings visible on first side 124 of target 122. In some cases, code 126 may be configured to be attached to target 122. For example, without limitation, code 126 may take the form of one or more stickers that may be removably or permanently attached to a material to form a coded target.

In some illustrative examples, second side 125 of target 122 may be magnetic. When second side 125 of target 122 is magnetic, target 122 may be referred to as magnetic target 123. In this illustrative example, magnetic target 123 may be a magnetic photogrammetric target. Of course, in other illustrative examples, second side 125 may be non-magnetic.

In one illustrative example, both first side 124 and second side 125 of magnetic target 123 may be magnetic. In this example, code 126 may take the form of a number of magnets configured to be magnetically attached to first side 124 of target 122. These magnets may take the form of magnetic stickers in some illustrative examples.

Number of retaining members 113 may be configured for use in removably attaching number of targets 112 to surface 104 of structure 106. Retaining member 128 may be an example of a retaining member in number of retaining members 113. Retaining member 128 may be used to hold one or more of number of targets 112. In one illustrative example, retaining member 128 may be used to hold target 122.

As depicted, retaining member 128 may have body 130. In one illustrative example, body 130 may be flexible but dimensionally stable. Body 130 may be flexible in that body 130 may be capable of bending. However, body 130 may be dimensionally stable in that body 130 may be fixed in size with respect to the dimensions of body 130. In other words, body 130 may be bendable but not stretchable or compressible.

Body 130 may have first side 132 and second side 134. In one illustrative example, magnetic material 136 may be associated with first side 132 of body 130 and engagement material 138 may be associated with second side 134 of body 130.

As used herein, when one component is “associated” with another component, the association is a physical association in the depicted examples. For example, a first component, such as magnetic material 136, may be considered to be associated with a second component, such as body 130, by being at least one of secured to the second component, bonded to the second component, mounted to the second component, welded to the second component, fastened to the second component, or connected to the second component in some other suitable manner. The first component also may be connected to the second component using a third component. Further, the first component may be considered to be associated with the second component by being formed as part of the second component, an extension of the second component, or both.

As used herein, the phrase “at least one of,” when used with a list of items, means different combinations of one or more of the listed items may be used and only one of the items in the list may be needed. The item may be a particular object, thing, action, process, or category. In other words, “at least one of” means any combination of items or number of items may be used from the list, but not all of the items in the list may be required.

For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In this manner, magnetic material 136 may form a portion of body 130 at first side 132 of body 130 or be connected to first side 132 of body 130. In one illustrative example, magnetic material 136 may take the form of magnetic paint 141 that is painted on first side 132 of body 130.

Magnetic material 136 may be used to hold magnetic target 123 in fixed position 140 relative to retaining member 128. In particular, magnetic material 136 may exert an attractive force on magnetic target 123. This attractive force may be sufficiently strong to hold magnetic target 123 when retaining member 128 is in different orientations. In particular, the attractive force may be sufficiently strong such that retaining member 128 is capable of holding magnetic target 123 absent any external forces.

Engagement material 138 may be used to removably attach retaining member 128 to surface 104 of structure 106. Engagement material 138 may take a number of different forms. Engagement material 138 may take the form of adhesive material 142, vinyl film 144, static cling material 146, some other type of material, or some combination thereof.

Adhesive material 142 and vinyl film 144 may have a number of properties selected such that adhesive material 142, and thereby retaining member 128, can be removed from surface 104 without having an undesired effect on surface 104 or structure 106. Static cling material 146 may be configured to cling to surface 104 of structure 106 using static electricity.

In one illustrative example, a combination of static cling material 146 and adhesive material 142 may be used. For example, without limitation, static cling material 146 may be used to removably attach body 130 to surface 104, but adhesive material 142 may be used to removably attach magnetic target 123 to body 130.

In one illustrative example, engagement material 138 may be used to first removably attach retaining member 128 to surface 104. Then, magnetic target 123 may be positioned relative to magnetic material 136. Magnetic material 136 may attract and hold magnetic target 123. Thus, magnetic target 123 may be removably attached to surface 104 without directly adhering magnetic target 123 to surface 104.

In other illustrative examples, first side 132 of retaining member 128 may take the form of non-adhesive side 148 and second side 134 of retaining member 128 may take the form of adhesive side 150. Code 126 may be visible at non-adhesive side 148. Adhesive side 150 may be used to removably attach retaining member 128 to surface 104.

In these examples, retaining member 128 may have set of stabilizing features 152 configured to hold target 122. Set of stabilizing features 152 may be unitary with body 130 of retaining member 128 in some cases. As used herein, a first object being “unitary” with a second object means that the first object and the second object are part of the same unit. For example, without limitation, the first object may form a portion of the second object. The portion of body 130 that forms set of stabilizing features 152 may be referred to as a stabilizing portion of body 130. In other illustrative examples, body 130 may have a number of stabilizing portions.

Set of stabilizing features 152 may be used to hold target 122 in fixed position 140 relative to retaining member 128. Set of stabilizing features 152 may hold target 122 in fixed position 140 relative to retaining member 128 such that target 122 may be removably attached to surface 104 when adhesive side 150 of retaining member 128 is used to removably attach retaining member 128 to surface 104. Thus, target 122 may be removably attached to surface 104 without directly adhering target 122 to surface 104.

Depending on the implementation, retaining member 128 may include multiples sets of stabilizing features such that multiple targets may be held by retaining member 128. These multiple sets of stabilizing features may be arranged such that targets may be held in fixed positions relative to retaining member 128 according to some predefined pattern or predefined spacing requirements.

Depending on the implementation, retaining member 128 may be implemented as sticker 156, decal 158, strip of tape 160, or some other type of object. Further, retaining member 128 may have shape 154. In particular, body 130 of retaining member 128 may have shape 154. Shape 154 may be selected from one of a square shape, a rectangular shape, a circular shape, an oval shape, a triangular shape, a cross-shape, an irregular shape, or some other type of shape.

Number of targets 112 may be removed from number of retaining members 113 without causing any undesired effects to number of targets 112, number of retaining members 113, or both. In this manner, number of targets 112 may be reusable or disposable, depending on the implementation.

For example, without limitation, magnetic target 123 may be removed from retaining member 128 and attached to a new retaining member at some later point in time. In particular, magnetic target 123 that has been removed from retaining member 128 may be positioned relative to a new retaining member and then later removably attached to another surface of a different structure using the new retaining member. In some cases, once magnetic target 123 is removed from retaining member 128, a new magnetic target may be removably attached to retaining member 128. The new magnetic target may have a different code than code 126, for example.

Further, in some illustrative examples, number of retaining members 113 may be reusable. In other illustrative examples, number of retaining members 113 may be disposable.

The illustration of photogrammetric environment 100 in FIG. 1 is not meant to imply physical or architectural limitations to the manner in which an illustrative embodiment may be implemented. Other components in addition to or in place of the ones illustrated may be used. Some components may be optional. Also, the blocks are presented to illustrate some functional components. One or more of these blocks may be combined, divided, or combined and divided into different blocks when implemented in an illustrative embodiment.

For example, although retaining member 128 is described as being configured to hold target 122, retaining member 128 may be configured to hold other targets in number of targets 112 in addition to or in place of target 122. In some illustrative examples, target 122 may not have code 126 at first side 124 of target 122. In other illustrative examples, number of targets 112 may be removably attached to the surface of more than one structure.

In one illustrative example, body 130 may be implemented in a manner differently than described above. For example, without limitation, body 130 may be comprised of a first portion and a second portion. The first portion may have a first inner surface and a first outer surface. The first outer surface may be located at first side 132 of body 130. The first portion of body 130 may be comprised of magnetic material 136. In this example, the second portion may have a second inner surface that contacts the first inner surface of the first portion of body 130 and a second outer surface that is located at second side 134 of body 130. Engagement material 138 may form a coating on the second outer surface of the second portion. The second portion of body 130 may be comprised of a material selected from one of a plastic material, a metal material, and a composite material.

In other illustrative examples, set of stabilizing features 152 may not be unitary with body 130. Instead, set of stabilizing features 152 may be associated with both body 130 and one of number of targets 112, such as target 122. For example, without limitation, set of stabilizing features 152 may take the form of set of hook-and-loop fasteners 162, set of snap fasteners 164, or a set of some other type stabilizing feature.

Set of hook-and-loop fasteners 162 may be comprised of a set of hooked strips associated with first side 132 of body 130 and a set of looped strips associated with second side 125 of target 122. Each of the set of hooked strips may be a fabric having hooks configured to a looped strip. Each of the set of looped strips may be a fabric having loops configured to engage a hooked strip. The set of looped strips may be engaged with the set of hooked strips to removably attach target 122 to retaining member 128.

Set of stabilizing features 152 may take the form of set of snap fasteners 164. Set of snap fasteners 164 may be comprised of a set of first discs and a set of second discs. A first disc in the set of first discs and a corresponding second disc in the set of second discs may form a pair of interlocking discs. For example, each of the set of first discs may be associated with first side 132 of body 130 and each of the set of second discs may be associated with second side 125 of target 122. The set of second discs may interlock with the set of first discs to removably attach target 122 to retaining member 128.

In one illustrative example, body 130 may be comprised of a fabric material to which the set of first discs are attached. In this example, the set of second discs may be attached to a fabric associated with target 122.

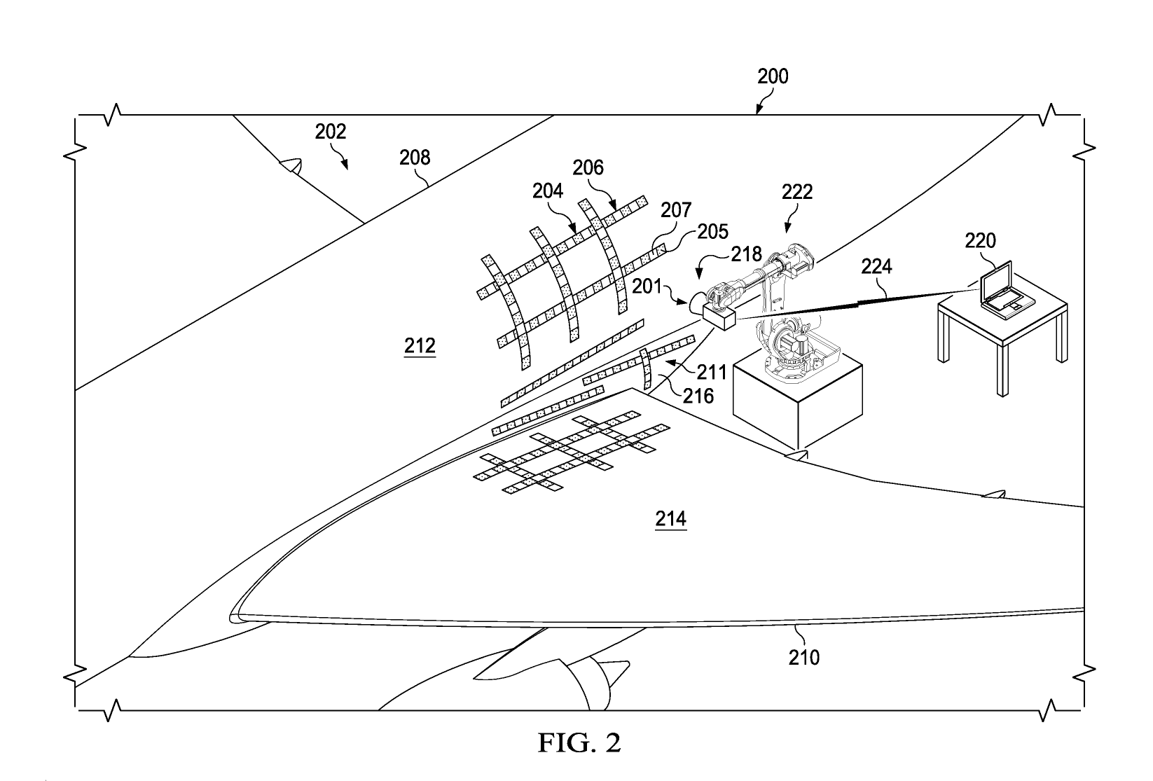

With reference now to FIG. 2, an illustration of an isometric view of a photogrammetric environment is depicted in accordance with an illustrative embodiment. In this illustrative example, photogrammetric environment 200 is an example of one implementation for photogrammetric environment 100 shown in block form in FIG. 1.

As depicted, photogrammetric environment 200 includes photogrammetry system 201 and aircraft 202. Photogrammetry system 201 may be an example of one implementation for photogrammetry system 108 in FIG. 1. In this illustrative example, photogrammetry system 201 includes number of magnetic targets 204 and number of retaining members 206. Number of magnetic targets 204 and number of retaining members 206 may be an example of one implementation for number of targets 112 and number of retaining members 113, respectively, in FIG. 1.

Magnetic target 205 may be an example of one of number of magnetic targets 204. Magnetic target 205 may be removably attached to aircraft 202 by retaining member 207. Retaining member 207 may be an example of one of number of retaining members 206. Magnetic target 205 and retaining member 207 may be examples of implementations for magnetic target 123 and retaining member 128, respectively, in FIG. 1.

In this illustrative example, number of retaining members 206 may be used to removably attach number of magnetic targets 204 to fuselage 208, wing 210, and interface 211 between wing 210 and fuselage 208. Fuselage 208, wing 210, and interface 211 may each be an example of one implementation for structure 106 in FIG. 1. Interface 211 may be referred to as a fillet panel or a wing-to-fuselage panel in some illustrative examples. At least one of fuselage 208, wing 210, or interface 211 may be at least partially fabricated using one or more composite materials.

Number of retaining members 206 may be used to removably attach number of magnetic targets 204 to surface 212 of fuselage 208, surface 214 of wing 210, and surface 216 of interface 211. Each of surface 212, 214, and 216 may be an example of one implementation for surface 104 in FIG. 1.

Photogrammetry system 201 may also include imaging system 218 and controller 220. Imaging system 218 may be associated with robotic device 222. Robotic device 222 may be configured to control operation and movement of imaging system 218 within photogrammetric environment 200. Imaging system 218 may be used to generate imaging data of aircraft 202 with number of magnetic targets 204 removably attached to aircraft 202. This imaging data may be sent to controller 220 over wireless communications link 224. Controller 220 may use the imaging data to generate an output, such as output 116 in FIG. 1.

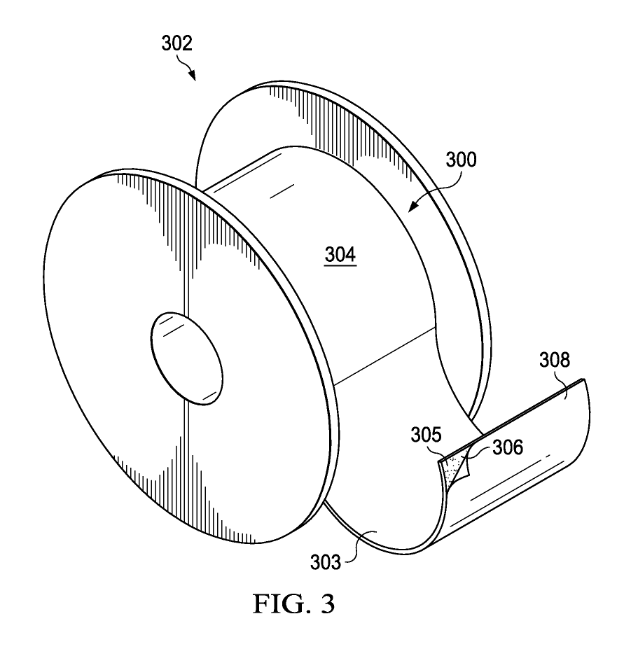

With reference now to FIG. 3, an illustration of a spool of retaining tape is depicted in accordance with an illustrative embodiment. In this illustrative example, retaining tape 300 may be wrapped around spool 302. Retaining tape 300 may be used to form number of retaining members 206 in FIG. 2. For example, without limitation, a strip of retaining tape 300 may be cut away to form each of number of retaining members 206.

Retaining tape 300 may have first side 303 and second side 305. First side 303 and second side 305 may be examples of first side 132 and second side 134, respectively, in FIG. 1. In this illustrative example, magnetic material 304 may be located on first side 303 of retaining tape 300 and engagement material 306 may be located on second side 305 of retaining tape 300. Magnetic material 304 and engagement material 306 may be examples of magnetic material 136 and engagement material 138, respectively, in FIG. 1.

In this illustrative example, paper 308 may be removably attached to second side 305 of retaining tape 300 to protect engagement material 306 until use. For example, without limitation, a strip of retaining tape 300 may be cut away to form retaining member 207 in FIG. 2. Paper 308 may then be removed from second side 305 when the retaining member is ready to be removably attached to surface 212 of fuselage 208 in FIG. 2.

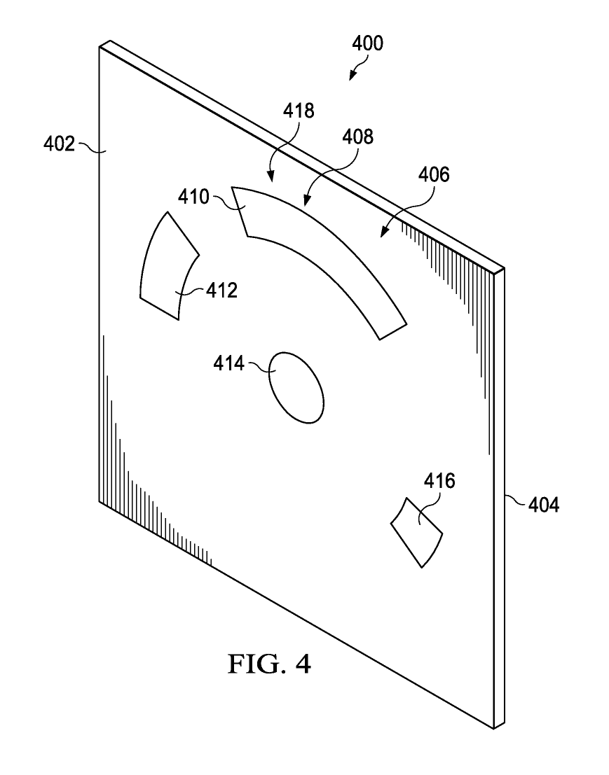

With reference now to FIG. 4, an illustration of a magnetic target is depicted in accordance with an illustrative embodiment. In this illustrative example, magnetic target 400 may be an example of one implementation for magnetic target 123 in FIG. 1. Further, magnetic target 400 may be an example of one of number of magnetic targets 204 in FIG. 2.

As depicted, magnetic target 400 may have first side 402 and second side 404. First side 402 and second side 404 may be examples of implementations for first side 132 and second side 134, respectively, in FIG. 1. At least second side 404 of magnetic target 400 may be magnetic.

In this illustrative example, code 406 is visible on first side 402. Magnetic target 400 may be referred to as a coded target or a coded magnetic target in some cases. Code 406 may be an example of one implementation for code 126 in FIG. 1. Code 406 may be formed by plurality of shapes 408. Plurality of shapes 408 may include shapes 410, 412, 414, and 416. As depicted, plurality of shapes 408 form pattern 418 on first side 402. Pattern 418 may be unique to magnetic target 400. Thus, code 406 may allow magnetic target 400 to be distinguishable from other magnetic targets in number of magnetic targets 204.

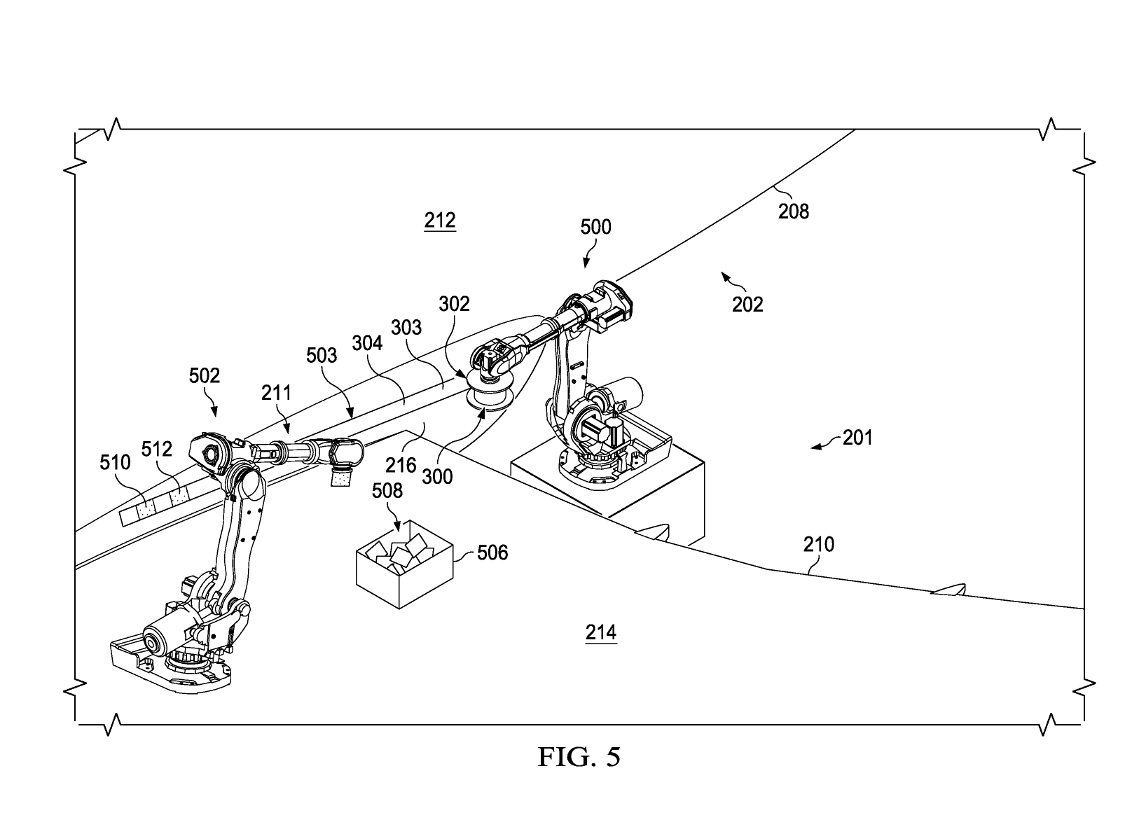

With reference now to FIG. 5, an illustration of magnetic targets being removably attached to surface 212 of fuselage 208 of aircraft 202 from FIG. 2 is depicted in accordance with an illustrative embodiment. Robotic device 500 and robotic device 502 may be positioned relative to aircraft 202.

In this illustrative example, robotic device 500 may be configured to hold spool 302 of retaining tape 300 from FIG. 3. Further, robotic device 500 may be used to removably attach retaining tape 300 to interface 211. Robotic device 500 may roll portion 503 of retaining tape 300 onto surface 216 of interface 211 and use engagement material 306 seen in FIG. 3 to removably attach portion 503 of retaining tape 300 onto surface 216.

In some cases, robotic device 500 may have an end effector device (not shown) capable of cutting retaining tape 300 to separate portion 503 from the rest of retaining tape 300 wrapped around spool 302. In this manner, portion 503 of retaining tape 300 may form a strip of retaining tape 300.

In this illustrative example, robotic device 502 may be used to removably attach at least a portion of magnetic targets 508 in box 506 onto aircraft 202. For example, without limitation, robotic device 502 may removably attach magnetic target 510 and magnetic target 512 onto first side 303 of portion 503 of retaining tape 300 to removably attach magnetic target 510 and magnetic target 512 to surface 216.

Robotic device 502 may position magnetic target 510 and magnetic target 512 relative to portion 503 of retaining tape 300. Magnetic material 304 on first side 303 of portion 503 of retaining tape 300 may attract and hold magnetic target 510 and magnetic target 512 in fixed positions relative to portion 503 of retaining tape 300.

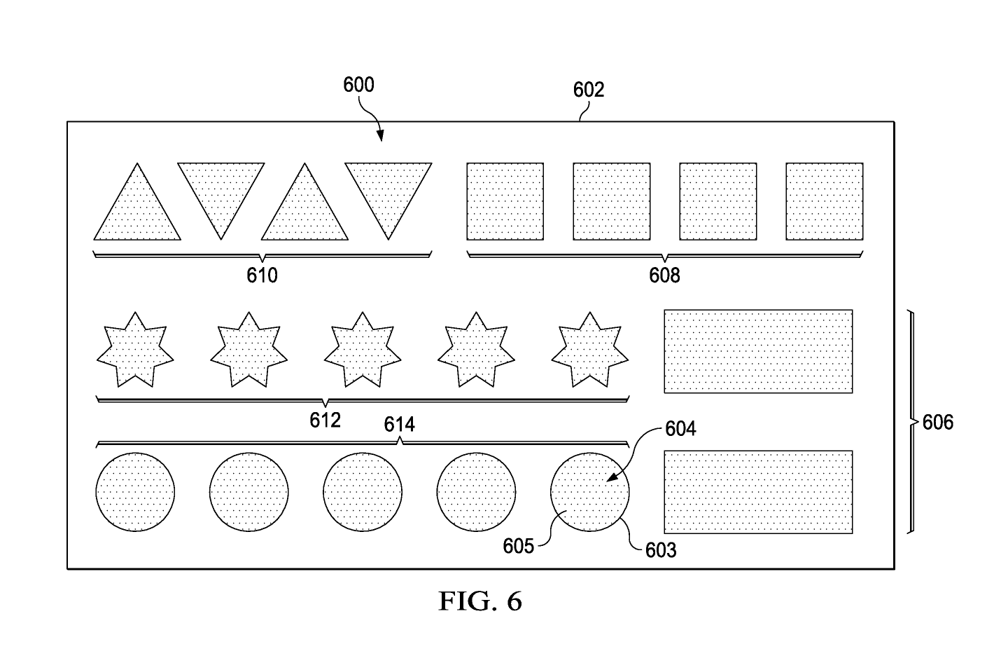

With reference now to FIG. 6, an illustration of a plurality of stickers is depicted in accordance with an illustrative embodiment. In this illustrative example, plurality of stickers 600 may be removably attached to backing 602. Each of plurality of stickers 600 may be an example of one implementation for retaining member 128 in FIG. 1.

A sticker in plurality of stickers 600 may be used to removably attach a magnetic target, such as magnetic target 400 in FIG. 4, to a surface, such as one of surfaces 212, 214, and 216 in FIG. 2. Sticker 603 may be an example of one of plurality of stickers 600. Sticker 603 may have magnetic material 604 located on first side 605 of sticker 603. An engagement material (not shown) may be located on the second side (not shown in this view) of sticker 603 that is in contact with backing 602.

As depicted, plurality of stickers 600 may include first type of stickers 606, second type of stickers 608, third type of stickers 610, fourth type of stickers 612, and fifth type of stickers 614. Each of these types of stickers may have a different shape. The selection of a sticker from plurality of stickers 600 may be made based on the shape, size, or both of the magnetic target configured to be removably attached to the sticker.

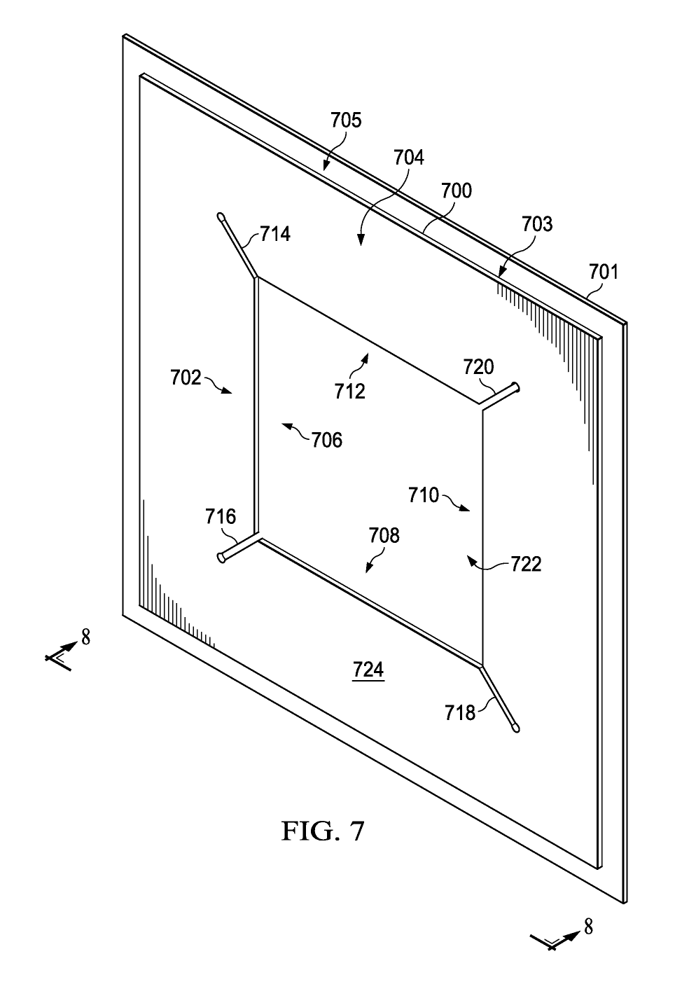

With reference now to FIG. 7, an illustration of an isometric view of a retaining member is depicted in accordance with an illustrative embodiment. In this illustrative example, retaining member 700 may be an example of one implementation for retaining member 128 in FIG. 1. As depicted, retaining member 700 may be associated with backing 701.

As depicted, retaining member 700 may have cutout portion 702 within body 703 of retaining member 700. Further, retaining member 700 may have set of stabilizing features 704 formed around cutout portion 702. Set of stabilizing features 704 may include stabilizing features 706, 708, 710, and 712.

Together, set of stabilizing features 704 form stabilizing portion 722 configured to hold a target (not shown), such as target 122 in FIG. 1, in a fixed position relative to retaining member 700. Each of set of stabilizing features 704 may take the form of a tab. As depicted, set of stabilizing features 704 may be unitary with body 703. Body 703 has square shape 705 in this illustrative example.

Slit 714 and slit 716 in retaining member 700 around cutout portion 702 may form stabilizing feature 706. Slit 716 and slit 718 in retaining member 700 around cutout portion 702 may form stabilizing feature 708. Slit 718 and slit 720 in retaining member 700 around cutout portion 702 may form stabilizing feature 710. Further, slit 720 and slit 714 in retaining member 700 around cutout portion 702 may form stabilizing feature 712.

Body 703 may have non-adhesive side 724 and an adhesive side (not shown) in this view. The adhesive side may be in contact with backing 701. Thus, retaining member 700 may take the form of a sticker removably attached to backing 701 until retaining member 700 is ready to be used.

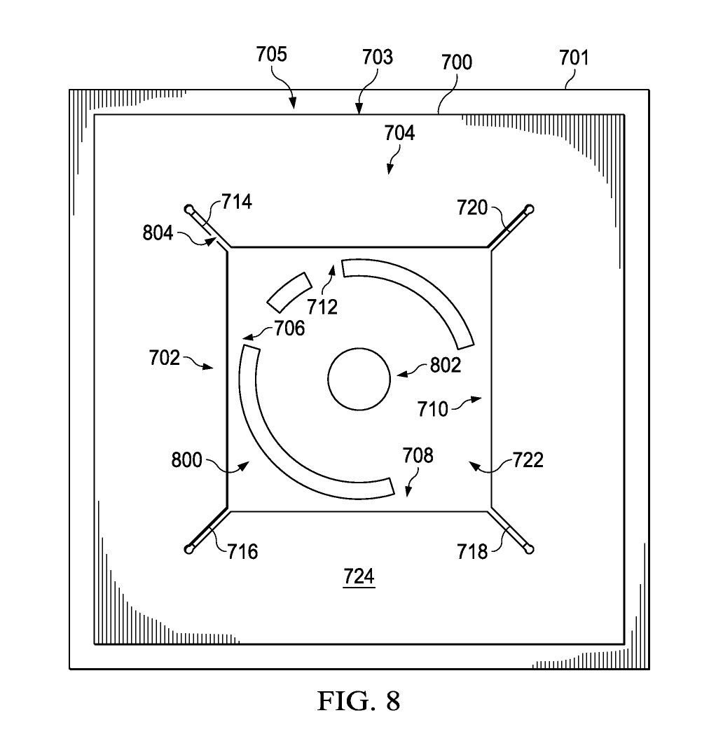

With reference now to FIG. 8, an illustration of a front view of retaining member 700 from FIG. 7 holding a coded target is depicted in accordance with an illustrative embodiment. In this illustrative example, a front view of retaining member 700 from FIG. 7 may be depicted in the direction of lines 8-8 in FIG. 7.

As depicted, retaining member 700 may be holding coded target 800 having code 802 visible at non-adhesive side 724 of retaining member 700. Coded target 800 may be an example of one implementation for target 122 in FIG. 1. In one illustrative example, coded target 800 may be a magnetic target.

Set of stabilizing features 704 may have been peeled away from cutout portion 702 to allow coded target 800 to be positioned relative to cutout portion 702. Set of stabilizing features 704 may then be removably attached to edges 804 of coded target 800. In particular, the adhesive side (not shown) of set of stabilizing features 704 may be used to removably attach set of stabilizing features 704 to edges 804 of coded target 800.

Retaining member 700 with coded target 800 may then be peeled away from backing 701 and removably attached to a surface of a structure, such as one of surfaces 212, 214, and 216 in FIG. 2. In this manner, coded target 800 may be indirectly removably attached to the surface using retaining member 700.

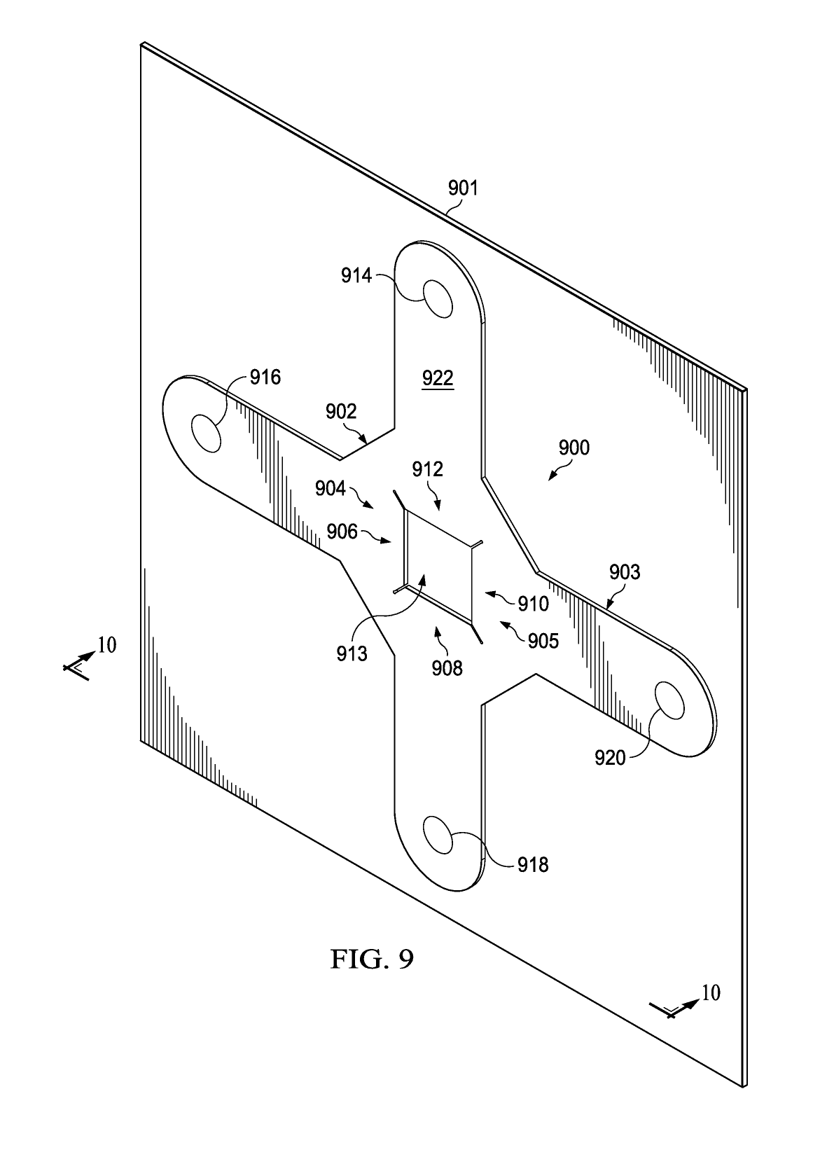

With reference now to FIG. 9, an illustration of an isometric view of a retaining member is depicted in accordance with an illustrative embodiment. In this illustrative example, retaining member 900 may be an example of one implementation for retaining member 128 in FIG. 1.

As depicted, retaining member 900 may be associated with backing 901 in this illustrative example. Retaining member 900 may take the form of a sticker removably attached to backing 901 until retaining member 900 is ready to be used. Retaining member 900 may be implemented in a manner similar to retaining member 700 in FIGS. 7-8. However, retaining member 900 may have body 902 with cross shape 903.

In this illustrative example, retaining member 900 may have cutout portion 904 with set of stabilizing features 905 formed around cutout portion 904. Set of stabilizing features 905 may be unitary with body 902 and may form stabilizing portion 913 of body 902. Set of stabilizing features 905 may include stabilizing features 906, 908, 910, and 912. Set of stabilizing features 905 may be configured for use in holding a target, such as target 122 in FIG. 1, in a fixed position relative to retaining member 900.

Locations 914, 916, 918, and 920 may be used to associate a different type of target (not shown) with retaining member 900. This target may take the form of, for example, without limitation, a sticker configured to be removably adhered to non-adhesive side 922 of body 902 of retaining member 900. Body 902 may have an adhesive side (not shown in this view) in contact with backing 901.

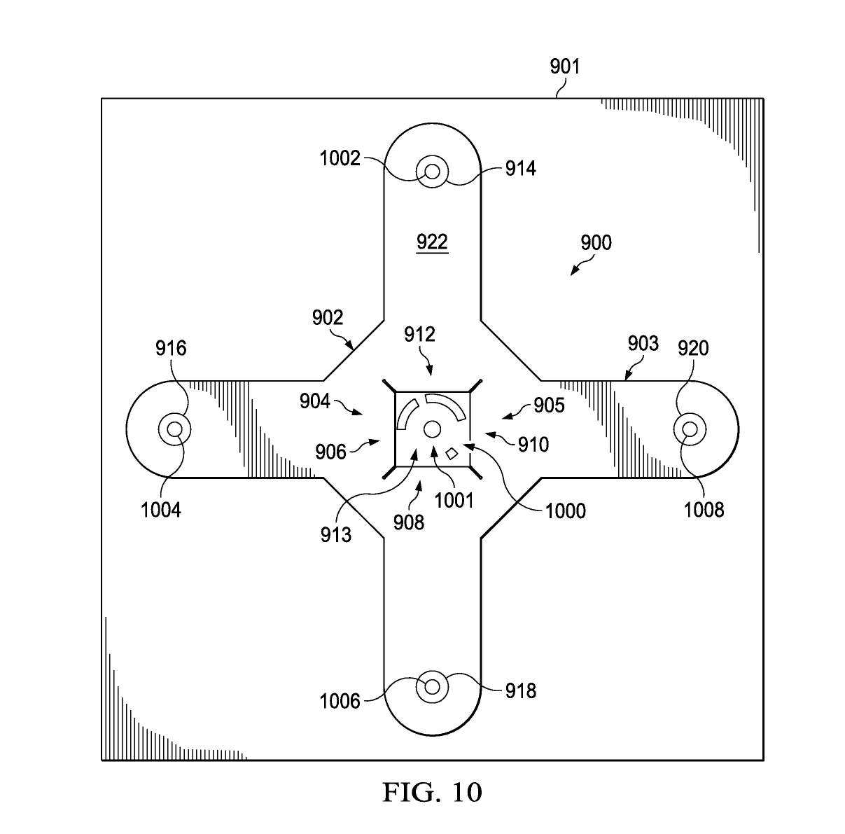

With reference now to FIG. 10, an illustration of a front view of retaining member 900 from FIG. 9 holding a target is depicted in accordance with an illustrative embodiment. In this illustrative example, a front view of retaining member 900 from FIG. 9 is depicted taken in the direction of lines 10-10 in FIG. 9.

As depicted, set of stabilizing features 905 may be used to hold coded target 1000. Coded target 1000 may be an example of one implementation for target 122 in FIG. 1. Coded target 1000 may have code 1001 visible at non-adhesive side 922 of body 902 of retaining member 900.

Further, targets 1002, 1004, 1006, and 1008 may also be removably attached to non-adhesive side 922 of body 902. Targets 1002, 1004, 1006, and 1008 may not be coded targets. Thus, targets 1002, 1004, 1006, and 1008 may not be unique or distinguishable from each other.

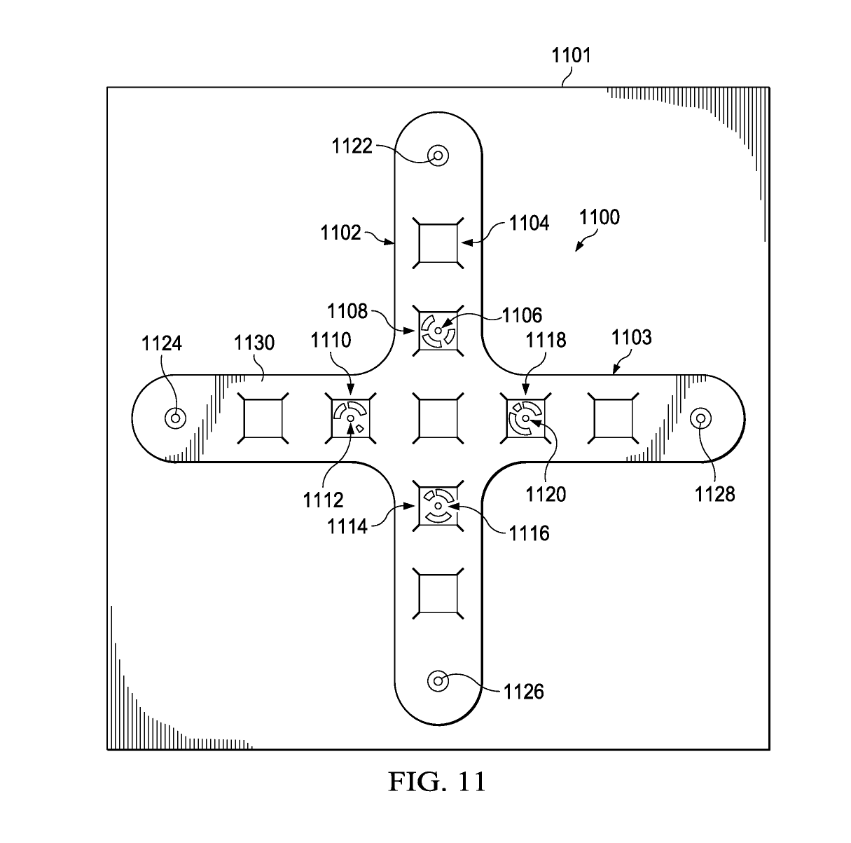

With reference now to FIG. 11, an illustration of a front view of a different type of retaining member is depicted in accordance with an illustrative embodiment. In this illustrative example, retaining member 1100 may be an example of yet another implementation for retaining member 128 in FIG. 1. In this illustrative example, retaining member 1100 may be implemented in a manner similar to retaining member 900 in FIG. 9.

However, retaining member 1100 may be configured to hold multiple coded targets. In particular, retaining member 1100 may have body 1102 with cross shape 1103. Body 1102 may have an adhesive side (not shown in this view) in contact with backing 1101.

Plurality of sets of stabilizing features 1104 may be distributed along cross shape 1103 of body 1102. Each set of stabilizing features in plurality of sets of stabilizing features 1104 may be configured for use in holding a coded target (not shown).

As depicted, retaining member 1100 may be used to hold coded target 1106 having code 1108, coded target 1110 having code 1112, coded target 1114 having code 1116, and coded target 1118 having code 1120. Codes 1108, 1112, 1116, and 1120 allow coded targets 1106, 1110, 1114, and 1118, respectively, to be distinguished from each other.

In this illustrative example, targets 1122, 1124, 1126, and 1128 may also be removably attached to non-adhesive side 1130 of body 1102. Targets 1122, 1124, 1126, and 1128 are not coded targets in this illustrative example.

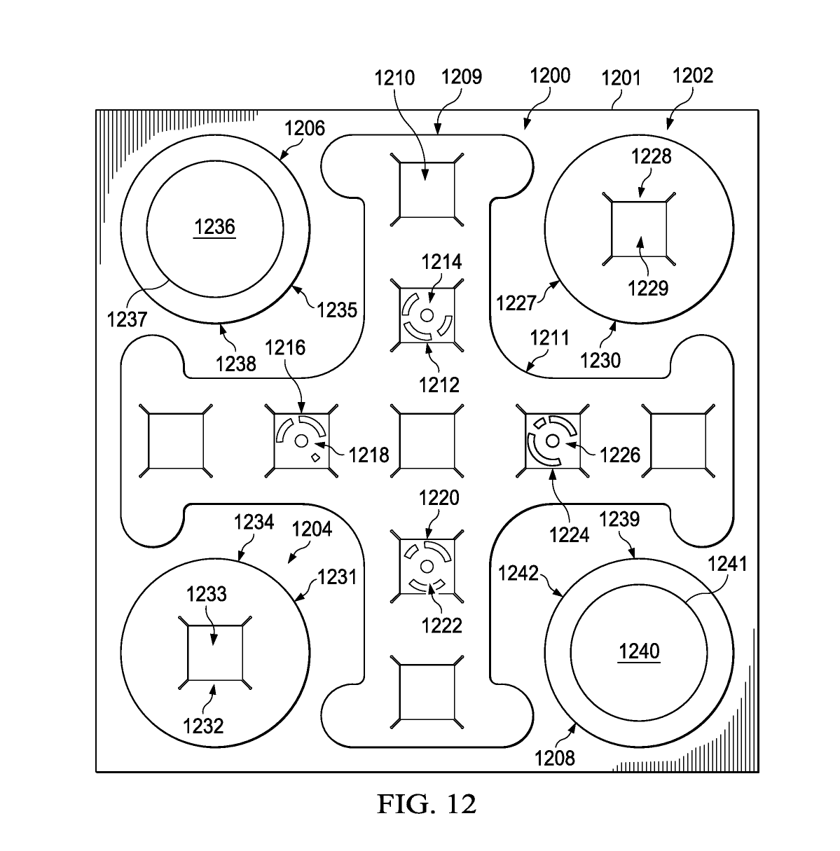

With reference now to FIG. 12, an illustration of a front view of different types of retaining members is depicted in accordance with an illustrative embodiment. In FIG. 12, an example of combining different embodiments to maximize material usage is depicted. In particular, different types of retaining members are formed on backing 1201.

In this illustrative example, retaining members 1200, 1202, 1204, 1206, and 1208 may be removably attached to backing 1201. Retaining members 1200, 1202, 1204, 1206, and 1208 may take the form of stickers.

Retaining member 1200 may have body 1209 with cross shape 1211. Cross shape 1211 may be different from cross shape 903 in FIGS. 9-10 and cross shape 1103 in FIG. 11. Body 1209 may have plurality of sets of stabilizing features 1210 unitary with body 1209. In this illustrative example, plurality of sets of stabilizing features 1210 may be used to hold coded target 1212 having code 1214, coded target 1216 having code 1218, coded target 1220 having code 1222, and coded target 1224 having code 1226.

Retaining member 1202 may have body 1227 with set of stabilizing features 1228 located around cutout portion 1229 of body 1227. Body 1227 may have circular shape 1230. Retaining member 1204 may have body 1231 with set of stabilizing features 1232 located around cutout portion 1233 of body 1231. Body 1231 may have circular shape 1234.

In this illustrative example, retaining member 1206 may have body 1235. Magnetic paint 1236 may be associated with portion 1237 of body 1235. Magnetic paint 1236 may be used to attract and hold a magnetic target (not shown), such as magnetic target 400 in FIG. 4. Body 1235 may have circular shape 1238.

Similarly, retaining member 1208 may have body 1239. Magnetic paint 1240 may be associated with portion 1241 of body 1239. Magnetic paint 1240 may be used to attract and hold a magnetic target (not shown), such as magnetic target 400 in FIG. 4. Body 1239 may have circular shape 1242.

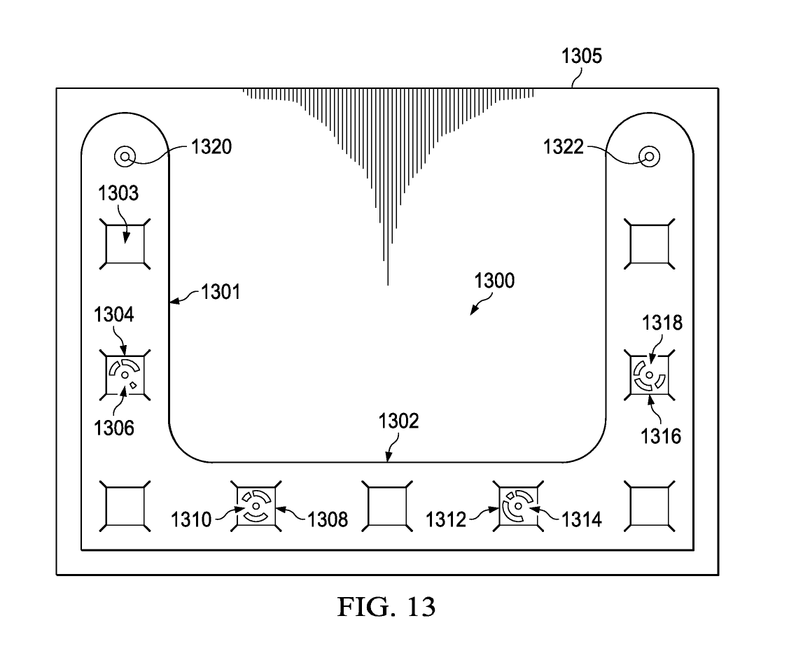

With reference now to FIG. 13, an illustration of a front view of another type of retaining member is depicted in accordance with an illustrative embodiment. In this illustrative example, retaining member 1300 may be an example of one implementation for retaining member 128 in FIG. 1. As depicted, retaining member 1300 may have body 1301 with U-shape 1302. Body 1301 may have an adhesive side (not shown in this view) in contact with backing 1305.

Retaining member 1300 may have plurality of sets of stabilizing features 1303. In this illustrative example, plurality of sets of stabilizing features 1303 may be used to hold coded target 1304 having code 1306, coded target 1308 having code 1310, coded target 1312 having code 1314, and coded target 1316 having code 1318.

In this illustrative example, target 1320 and target 1322 may also be removably attached to body 1301. Target 1320 and target 1322 are not coded targets in this illustrative example.

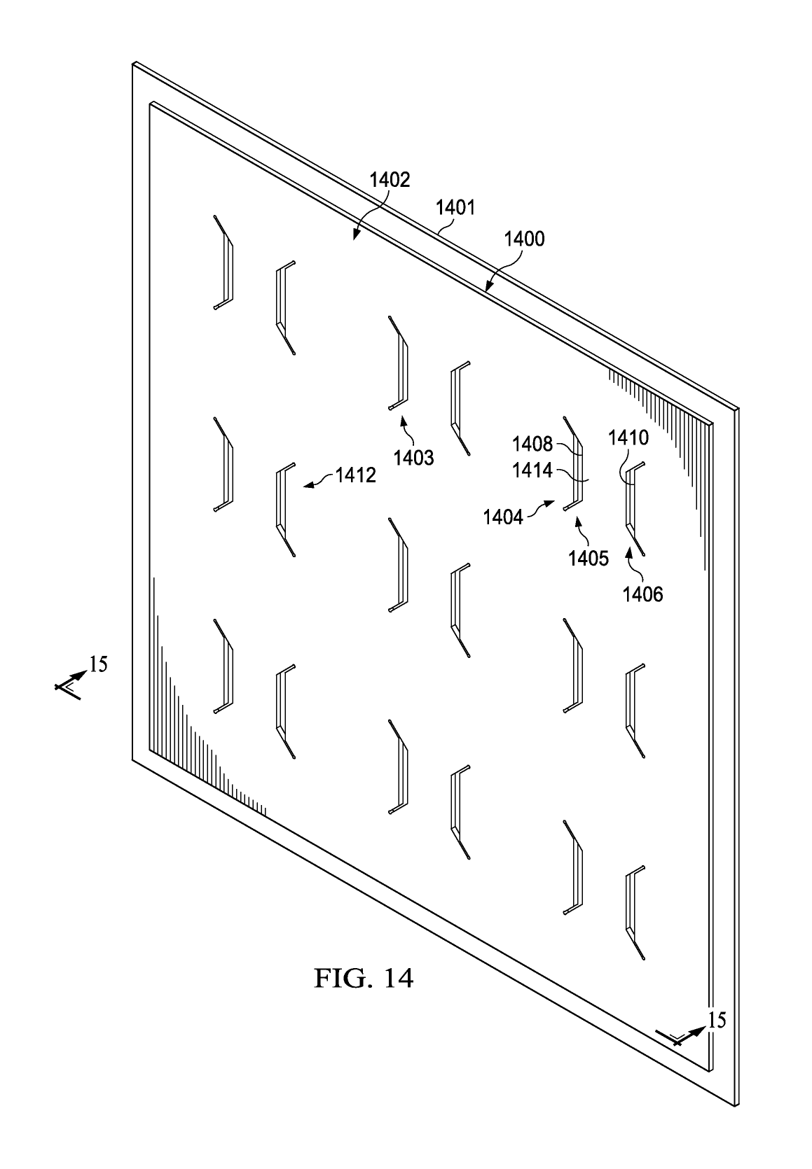

With reference now to FIG. 14, an illustration of an isometric view of a retaining member is depicted in accordance with an illustrative embodiment. Retaining member 1400 may be another example of one implementation for retaining member 128 in FIG. 1. Retaining member 1400 may be associated with backing 1401.

In this illustrative example, retaining member 1400 may have body 1402 with plurality of sets of stabilizing features 1403. Set of stabilizing features 1404 may be an example of one of plurality of sets of stabilizing features 1403. As depicted, set of stabilizing features 1404 may include stabilizing feature 1405 and stabilizing feature 1406. Stabilizing feature 1405 and stabilizing feature 1406 may be formed by opening 1408 and opening 1410, respectively, in body 1402. Plurality of openings 1412 in body 1402 may form plurality of sets of stabilizing features 1403.

As depicted, supporting portion 1414 may be formed between stabilizing feature 1405 and stabilizing feature 1406. Supporting portion 1414 may be used to support a target (not shown) secured by set of stabilizing features 1403.

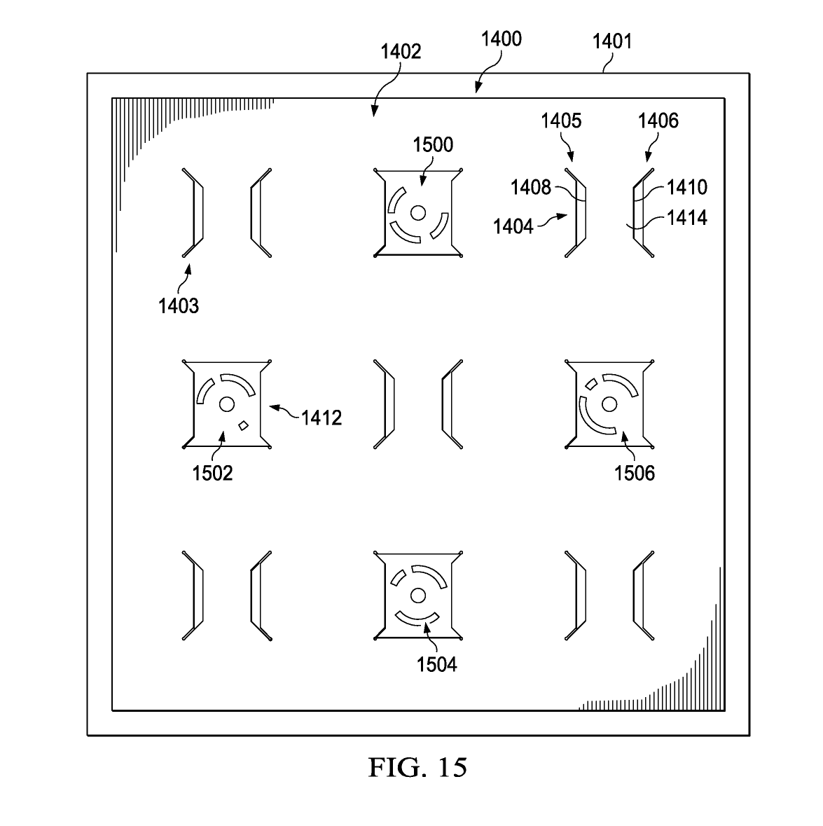

With reference now to FIG. 15, an illustration of a front view of retaining member 1400 from FIG. 14 is depicted in accordance with an illustrative embodiment. In this illustrative example, a front view of retaining member 1400 from FIG. 14 is depicted taken in the direction of lines 15-15 in FIG. 14. As depicted, retaining member 1400 may be used to hold coded targets 1500, 1502, 1504, and 1506.

The illustrations of photogrammetric environment 200 in FIG. 2, retaining tape 300 in FIG. 3, magnetic target 400 in FIG. 4, robotic device 500 and robotic device 502 in FIG. 5, plurality of stickers 600 in FIG. 6, retaining member 700 in FIGS. 7-8, retaining member 900 in FIGS. 9-10, retaining member 1100 in FIG. 11, retaining member 1200 in FIG. 12, retaining member 1300 in FIG. 13, and retaining member 1400 in FIGS. 14-15 are not meant to imply physical or architectural limitations to the manner in which an illustrative embodiment may be implemented. Other components in addition to or in place of the ones illustrated may be used. Some components may be optional.

The different components shown in FIGS. 2-15 may be illustrative examples of how components shown in block form in FIG. 1 can be implemented as physical structures. Additionally, some of the components in FIGS. 2-15 may be combined with components in FIG. 1, used with components in FIG. 1, or a combination of the two.

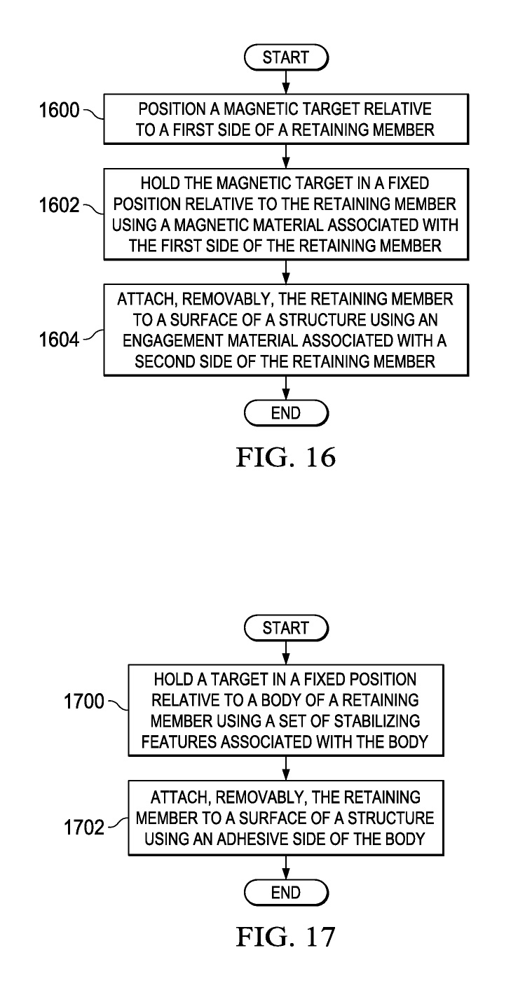

With reference now to FIG. 16, an illustration of a process for removably attaching a magnetic target for a photogrammetry system to a surface of a structure is depicted in the form of a flowchart in accordance with an illustrative embodiment. The process illustrated in FIG. 16 may be implemented to removably attach magnetic target 123 for photogrammetry system 108 to surface 104 of structure 106 in FIG. 1.

The process may begin by positioning magnetic target 123 relative to first side 132 of retaining member 128 (operation 1600). Next, magnetic target 123 may be held in fixed position 140 relative to retaining member 128 using magnetic material 136 associated with first side 132 of retaining member 128 (operation 1602). Thereafter, retaining member 128 may be removably attached to surface 104 of structure 106 using engagement material 138 associated with second side 134 of retaining member 128 (operation 1604), with the process terminating thereafter.

With reference now to FIG. 17, an illustration of a process for removably attaching a target for a photogrammetry system to a surface of a structure is depicted in the form of a flowchart in accordance with an illustrative embodiment. The process illustrated in FIG. 17 may be implemented to removably attach target 122 for photogrammetry system 108 to surface 104 of structure 106 in FIG. 1.

The process may begin by holding target 122 in fixed position 140 relative to body 130 of retaining member 128 using set of stabilizing features 152 associated with body 130 (operation 1700). Retaining member 128 may then be removably attached to surface 104 of structure 106 using adhesive side 150 of body 130 (operation 1702), with the process terminating thereafter.

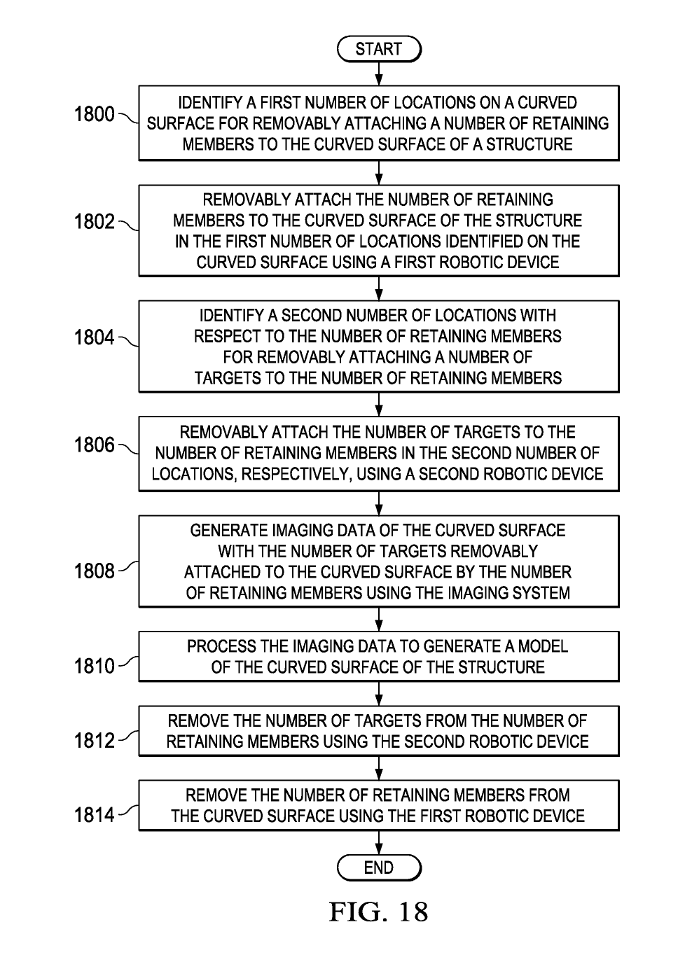

With reference now to FIG. 18, an illustration of a process for using photogrammetry to generate a three-dimensional model of a structure is depicted in the form of a flowchart in accordance with an illustrative embodiment. The process illustrated in FIG. 18 may be used to removably attach, for example, without limitation, number of targets 112 to curved surface 105 of structure 106 using number of retaining members 113 in FIG. 1.

Structure 106 may take the form of an aircraft structure such as, for example, without limitation, a fuselage, a wing, a curved interface between the fuselage and wing of an aircraft, a tail, or some other type of aircraft structure. Of course, in other illustrative examples, structure 106 may take some other form.

The process may begin by identifying a first number of locations on curved surface 105 for removably attaching number of retaining members 113 to curved surface 105 of structure 106 (operation 1800). In operation 1800, the number of locations for number of retaining members 113 may be identified using, for example, without limitation, a computer-aided design (CAD) model of structure 106. Next, number of retaining members 113 may be removably attached to curved surface 105 of structure 106 in the first number of locations identified on curved surface 105 using a first robotic device (operation 1802).

Thereafter, a second number of locations with respect to number of retaining members 113 may be identified for removably attaching number of targets 112 to number of retaining members 113 (operation 1804). Number of targets 112 may then be removably attached to number of retaining members 113 in the second number of locations, respectively, using a second robotic device (operation 1806).

Imaging data 102 of curved surface 105 with number of targets 112 removably attached to curved surface 105 by number of retaining members 113 may be generated using imaging system 110 (operation 1808). Imaging data 102 may be processed to generate model 118 of curved surface 105 of structure 106 (operation 1810). In operation 1810, model 118 may be a three-dimensional model.

Next, number of targets 112 may be removed from number of retaining members 113 using the second robotic device (operation 1812). Number of targets 112 may be reusable for performing photogrammetry at a later point in time and/or on a different structure. Then, number of retaining members 113 may be removed from curved surface 105 using the first robotic device (operation 1814), with the process terminating thereafter. In some illustrative examples, number of retaining members 113 may be reusable. In other illustrative examples, number of retaining members 113 may be disposable.

Although some of the operations in FIG. 18 are described as being performed by a first robotic device and a second robotic device, one or more of these operations may be performed by a human operator in other illustrative examples. For example, without limitation, the removal of number of retaining members 113 from curved surface 105 in operation 1814 may be performed by a human operator.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent a module, a segment, a function, a portion of an operation or step, some combination thereof.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

For example, without limitation, operation 1702 may be performed prior to operation 1700 in FIG. 17. In some illustrative examples, operation 1604 may be performed prior to operation 1600 in FIG. 16.

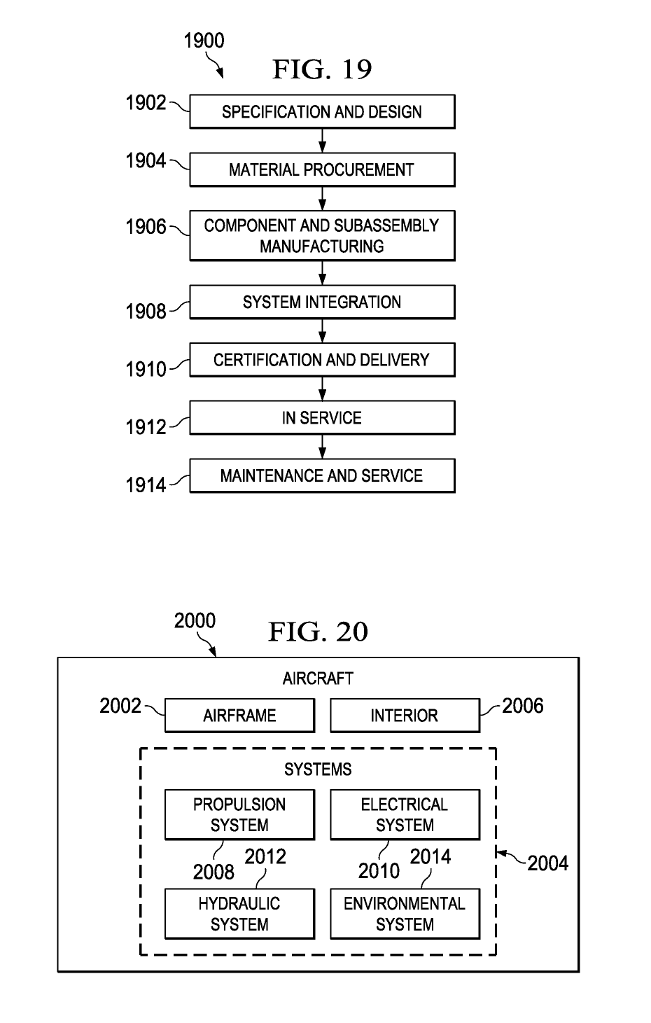

Illustrative embodiments of the disclosure may be described in the context of aircraft manufacturing and service method 1900 as shown in FIG. 19 and aircraft 2000 as shown in FIG. 20. Turning first to FIG. 19, an illustration of an aircraft manufacturing and service method is depicted in the form of a block diagram in accordance with an illustrative embodiment. During pre-production, aircraft manufacturing and service method 1900 may include specification and design 1902 of aircraft 2000 in FIG. 20 and material procurement 1904.

During production, component and subassembly manufacturing 1906 and system integration 1908 of aircraft 2000 in FIG. 20 takes place. Thereafter, aircraft 2000 in FIG. 20 may go through certification and delivery 1910 in order to be placed in service 1912. While in service 1912 by a customer, aircraft 2000 in FIG. 20 is scheduled for routine maintenance and service 1914, which may include modification, reconfiguration, refurbishment, and other maintenance or service.

Each of the processes of aircraft manufacturing and service method 1900 may be performed or carried out by at least one of a system integrator, a third party, or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 20, an illustration of an aircraft is depicted in the form of a block diagram in which an illustrative embodiment may be implemented. In this example, aircraft 2000 is produced by aircraft manufacturing and service method 1900 in FIG. 19 and may include airframe 2002 with plurality of systems 2004 and interior 2006. Examples of systems 2004 include one or more of propulsion system 2008, electrical system 2010, hydraulic system 2012, and environmental system 2014. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1900 in FIG. 19. In particular, photogrammetry system 108 from FIG. 1 may be used to model the surface of any number of structures of aircraft 2000 during any one of the stages of aircraft manufacturing and service method 1900. For example, without limitation, photogrammetry system 108 from FIG. 1 may be used to model the surface of a structure of aircraft 2000 during at least one of component and subassembly manufacturing 1906, system integration 1908, certification and delivery 1910, in service 1912, routine maintenance and service 1914, or some other stage of aircraft manufacturing and service method 1900.

As one illustrative example, number of targets 112 from FIG. 1 may be removably attached to number of retaining members 113 in FIG. 1. Number of retaining members 113 may then be removably attached to the surface of aircraft 2000 to indirectly removably attach number of targets 112 for photogrammetry system 108 to the surface of aircraft 2000. In one illustrative example, number of retaining members 113 may be removably attached to airframe 2002, propulsion system 2008, or some other portion of aircraft 2000. Photogrammetry system 108 may generate imaging data 102 of number of targets 112 on the surface of aircraft 2000 that may then be used to generate a three-dimensional model of the surface of aircraft 2000.

In one illustrative example, components or subassemblies produced in component and subassembly manufacturing 1906 in FIG. 19 may be fabricated or manufactured in a manner similar to components or subassemblies produced while aircraft 2000 is in service 1912 in FIG. 19. As yet another example, one or more apparatus embodiments, method embodiments, or a combination thereof may be utilized during production stages, such as component and subassembly manufacturing 1906 and system integration 1908 in FIG. 19. One or more apparatus embodiments, method embodiments, or a combination thereof may be utilized while aircraft 2000 is in service 1912, during maintenance and service 1914 in FIG. 19, or both. The use of a number of the different illustrative embodiments may substantially expedite the assembly of and reduce the cost of aircraft 2000.

Thus, the illustrative embodiments provide a retaining member, such as retaining member 128 in FIG. 1, which may be used to indirectly removably attach a target for a photogrammetry system, such as target 122 for photogrammetry system 108 in FIG. 1, to the surface of a structure, such as surface 104 of structure 106 in FIG. 1. Retaining member 128 may provide a means of removably attaching any number of targets onto surface 104 at the same time. Using retaining member 128 may reduce the overall time, effort, and cost needed to perform photogrammetry. Further, using retaining member 128 to hold and stabilize the targets may improve the accuracy of the output generated using photogrammetry.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A retaining member comprising:
a body;
an engagement material associated with the body and configured for use in removably attaching the retaining member to a surface of a structure; and
a magnetic material associated with the body and configured for use in removably attaching a magnetic target to the retaining member.

2. The retaining member of claim 1, wherein the magnetic material is associated with a first side of the body and the engagement material is associated with a second side of the body.

3. The retaining member of claim 1, wherein the magnetic target is a magnetic photogrammetric target for a photogrammetry system and wherein the retaining member is configured to hold the magnetic target in a fixed position relative to the retaining member using the magnetic material.

4. The retaining member of claim 1, wherein the magnetic material exerts an attractive force sufficiently strong to hold the magnetic target when the retaining member is in different orientations.

5. The retaining member of claim 1, wherein the magnetic material is magnetic paint.

6. The retaining member of claim 1, wherein the engagement material is an adhesive material having a number of properties selected such that the retaining member can be removed from the surface of the structure without having an undesired effect on the structure.

7. The retaining member of claim 1, wherein the engagement material is a vinyl film.

8. The retaining member of claim 7, wherein the engagement material is a static cling material configured to cling to the surface of the structure using static electricity.

9. The retaining member of claim 1, wherein the retaining member is selected from one of a sticker, a decal, and a strip of tape.

10. The retaining member of claim 1, wherein the retaining member has a shape selected from one of a square shape, a rectangular shape, a circular shape, an oval shape, a triangular shape, a cross-shape, and an irregular shape.

11. The retaining member of claim 1, wherein the body comprises:
a first portion having a first inner surface and a first outer surface in which the first outer surface is located at a first side of the body, wherein the first portion is comprised of the magnetic material; and
a second portion having a second inner surface that contacts the first inner surface of the first portion and a second outer surface that is located at a second side of the body in which the engagement material forms a coating on the second outer surface of the second portion, wherein the second portion is comprised of a material selected from one of a plastic material, a metal material, and a composite material.

12. The retaining member of claim 1, wherein the surface is a curved surface.

13. A retaining member comprising:
a body having a non-adhesive side and an adhesive side, wherein the adhesive side is configured for use in removably attaching the retaining member to a surface of a structure; and
a set of stabilizing features associated with the body and configured to hold a photogrammetric target in a fixed position relative to the body when the retaining member is removably attached to the surface of the structure.

14. The retaining member of claim 13, wherein a stabilizing feature in the set of stabilizing features is a tab having a first side and a second side in which the second side is adhesive and configured to adhere to the photogrammetric target.

15. The retaining member of claim 14, wherein the second side of the stabilizing feature is configured to adhere to an edge of a coded side of the photogrammetric target.

16. The retaining member of claim 14, wherein the set of stabilizing features is unitary with the body.

17. The retaining member of claim 16, wherein the body comprises:
a cutout portion, wherein the set of stabilizing features are formed around the cutout portion.

18. The retaining member of claim 13, wherein the photogrammetric target is for a photogrammetry system and has a code visible at the non-adhesive side of the body when the photogrammetric target is held by the retaining member.

19. The retaining member of claim 13, wherein the body has a shape selected from one of a square shape, a rectangular shape, a circular shape, an oval shape, a triangular shape, a cross-shape, and an irregular shape.

20. A photogrammetry system comprising:
a number of magnetic targets;
a number of retaining members configured for use in removably attaching the number of magnetic targets to a curved surface of a structure in which a retaining member in the number of retaining members comprises:
a body having a first side and a second side;
a magnetic material associated with the first side of the body in which the retaining member is configured to hold a magnetic target for the photogrammetry system in a fixed position relative to the retaining member using the magnetic material; and
an engagement material associated with the second side of the body in which the retaining member is configured to be removably attached to the curved surface of the structure using the engagement material; and
an imaging system configured to generate imaging data of the curved surface of the structure with the number of magnetic targets removably attached to the curved surface of the structure for use in generating a three-dimensional model of the curved surface of the structure.

21. A method for removably attaching a magnetic target for a photogrammetry system to a surface of a structure, the method comprising:
attaching, removably, a retaining member to the surface of the structure using an engagement material; and
attaching, removably, the magnetic target to the retaining member using a magnetic material associated with the retaining member.

22. The method of claim 21, wherein attaching, removably, the magnetic target to the retaining member comprises:
positioning the magnetic target relative to a first side of the retaining member; and
holding the magnetic target in a fixed position relative to the retaining member using the magnetic material, wherein the magnetic material is associated with the first side of the retaining member.

23. The method of claim 21, wherein attaching, removably, the retaining member to the surface of the structure comprises:
attaching, removably, the retaining member to the surface of the structure using the engagement material prior to attaching the magnetic target to the retaining member.

24. The method of claim 21, wherein attaching, removably, the retaining member to the surface of the structure comprises:
attaching, removably, the retaining member to the surface of the structure using the engagement material after attaching the magnetic target to the retaining member.

25. The method of claim 21 further comprising:
removing the magnetic target from the retaining member; and
attaching a new magnetic target to the retaining member.

26. The method of claim 25 further comprising:
positioning the magnetic target that has been removed from the retaining member relative to a new retaining member; and
attaching, removably, the magnetic target to another surface of a different structure using the new retaining member.

27. The method of claim 21, wherein attaching, removably, the magnetic target to the retaining member using the magnetic material comprises:
positioning the magnetic target relative to the retaining member; and
exerting an attractive force at the magnetic target by the magnetic material such that the retaining member is capable of holding the magnetic target absent any external forces.

28. The method of claim 21 further comprising:
generating imaging data of the surface of the structure with the magnetic target removably attached to the structure by the retaining member using the photogrammetry system.

29. A method for removably attaching a photogrammetric target for a photogrammetry system to a surface of a structure, the method comprising:
holding the photogrammetric target in a fixed position relative to a body of a retaining member using a set of stabilizing features associated with the body; and
attaching, removably, the retaining member to the surface of the structure using an adhesive side of the body.

30. The method of claim 29, wherein holding the photogrammetric target in the fixed position relative to the body of the retaining member using the set of stabilizing features associated with the body comprises:
holding the photogrammetric target in the fixed position relative to the body of the retaining member using the set of stabilizing features in which the set of stabilizing features is unitary with the body and in which a stabilizing feature in the set of stabilizing features adheres to the photogrammetric target by the adhesive side.
